(19) United States
(12) Patent Application Publication
(10) Pub. No.: US 2022/0121963 A1
(43) Pub. Date: Apr. 21, 2022

(54) NETWORK OPERATOR PROCESSING METHOD, APPARATUS, ELECTRONIC DEVICE AND STORAGE MEDIUM

(71) Applicant: BEIJING BAIDU NETCOM SCIENCE AND TECHNOLOGY CO., LTD., Beijing (CN)

(72) Inventors: Ming Jia, Beijing (CN); Yangkai Xu, Beijing (CN); Guibin Wang, Beijing (CN)

(73) Assignee: BEIJING BAIDU NETCOM SCIENCE AND TECHNOLOGY CO., LTD., Beijing (CN)

(21) Appl. No.: 17/360,526

(22) Filed: Jun. 28, 2021

(30) Foreign Application Priority Data
Oct. 15, 2020 (CN) 202011105939.6

(51) Int. Cl. G06N 5/02; G06N 3/08

(52) U.S. Cl. CPC G06N 5/02; G06N 3/08

(57) ABSTRACT

The present disclosure provides a network operator processing method, apparatus, electronic device and storage medium and relates to the field of artificial intelligence such as deep learning and knowledge graph. The method may include: regarding any operator in the network, performing condition analysis on the operator respectively; regarding the operator as an operator supporting spatial reuse and found from lookup if it is determined according to an analysis result that the operator satisfies a spatial reuse condition. The solution of the present disclosure may be applied to save manpower and time costs, and improve the accuracy of the lookup result.

### CROSS-REFERENCE TO RELATED APPLICATIONS

The present application claims the priority of Chinese Patent Application No. 202011105939.6, filed on Oct. 15, 2020, with the title of “Network operator processing method, apparatus, electronic device and storage medium.” The disclosure of the above application is incorporated herein by reference in its entirety.

### TECHNICAL FIELD

The present disclosure relates to the field of artificial intelligence, and particularly to a network operator processing method, apparatus, electronic device and storage medium in the field of deep learning and knowledge graph.

### BACKGROUND

In an actual model training process of a deep learning framework, it is necessary to reduce a video memory and increase an operating speed as much as possible to improve the operating efficiency. Each operator under the deep learning framework needs several video memory spaces to store the input data and output data (an output result) of the operator. However, for some operators, the output data thereof may reuse the space of the input data, so that the purpose of saving storage space can be achieved. In speech, there are a lot of tasks of for example using the user's voice online to train a personalized model, which imposes very high requirements for a training speed and a video memory size.

At present, to perform spatial reuse, a manner of manually looking up the network for an operator supporting spatial reuse is usually employed, but this manner requires consumption of large manpower and time costs, and manual operations are very prone to errors and exhibit a poor accuracy.

### SUMMARY

The present disclosure provides a network operator processing method, apparatus, electronic device and storage medium.

A network operator processing method includes regarding any operator in the network, performing condition analysis on the operator respectively; regarding the operator as an operator supporting spatial reuse and found from lookup if it is determined according to an analysis result that the operator satisfies a spatial reuse condition.

An electronic device includes at least one processor; and a memory communicatively connected with the at least one processor; wherein the memory stores instructions executable by the at least one processor, and the instructions are executed by the at least one processor to enable the at least one processor to perform a network operator processing method, wherein the method includes: regarding any operator in the network, performing condition analysis on the operator respectively, and regarding the operator as an operator supporting spatial reuse and found from lookup if it is determined according to an analysis result that the operator satisfies a spatial reuse condition.

A non-transitory computer readable storage medium with computer instructions stored thereon, wherein the computer instructions are used for causing a computer to perform a network operator processing method, wherein the method includes: regarding any operator in the network, performing condition analysis on the operator respectively; regarding the operator as an operator supporting spatial reuse and found from lookup if it is determined according to an analysis result that the operator satisfies a spatial reuse condition.

An embodiment of the present disclosure has the following advantages or advantageous effects: the operator that supports spatial reuse in the network can be automatically found from lookup, thereby saving manpower and time costs, and avoiding errors that might occur in manual operations, thereby improving the accuracy of the lookup result.

It will be appreciated that the Summary part does not intend to indicate essential or important features of embodiments of the present disclosure or to limit the scope of the present disclosure. Other features of the present disclosure will be made apparent by the following description.

### BRIEF DESCRIPTION OF THE DRAWINGS

The figures are only intended to facilitate understanding the solutions, not to limit the present disclosure. In the figures,

FIG. 1 illustrates a flow chart of a first embodiment of a network operator processing method according to the present disclosure;

FIG. 2 illustrates a schematic diagram of an operator graph according to the present disclosure;

FIG. 3 illustrates a schematic diagram of a second embodiment of a network operator processing method according to the present disclosure;

FIG. 4 illustrates a structural schematic diagram of an embodiment of a network operator processing apparatus 40 according to the present disclosure; and

FIG. 5 illustrates a block diagram of an electronic device for implementing the method according to embodiments of the present disclosure.

### DETAILED DESCRIPTION

Exemplary embodiments of the present disclosure are described below with reference to the accompanying drawings, include various details of the embodiments of the present disclosure to facilitate understanding, and should be considered as being only exemplary. Therefore, those having ordinary skill in the art should recognize that various changes and modifications can be made to the embodiments described herein without departing from the scope and spirit of the application. Also, for the sake of clarity and conciseness, depictions of well-known functions and structures are omitted in the following description.

In addition, the term “and/or” used in the text is only an association relationship depicting associated objects and represents that three relations might exist, for example, A and/or B may represents three cases, namely, A exists individually, both A and B coexist, and B exists individually. In addition, the symbol “I” in the text generally indicates associated objects before and after the symbol are in an “or” relationship.

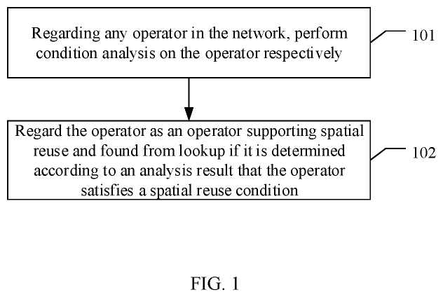

FIG. 1 illustrates a flow chart of a first embodiment of a network operator processing method according to the present disclosure. As shown in FIG. 1, the embodiment includes the following specific implementation mode:

In step 101, regarding any operator in the network, condition analysis is performed on the operator respectively.

In step 102, if it is determined according to an analysis result that the operator satisfies a spatial reuse condition, the operator is regarded as an operator supporting spatial reuse and found from lookup.

It can be seen that in the above embodiment, the operator that supports spatial reuse in the network can be automatically found from lookup, thereby saving manpower and time costs, and avoiding errors that might occur in manual operations, thereby improving the accuracy of the lookup result.

As stated in step 101, regarding any operator in the network, condition analysis may be performed on the operator. As a preferred implementation, the operators in an operator graph corresponding to the network may be traversed in a predetermined order, and each node in the operator graph corresponds to a different operator in the network, and the corresponding nodes are connected by edges according to a data transmission between the operators. As for any operator traversed, the condition analysis may be performed on the operator.

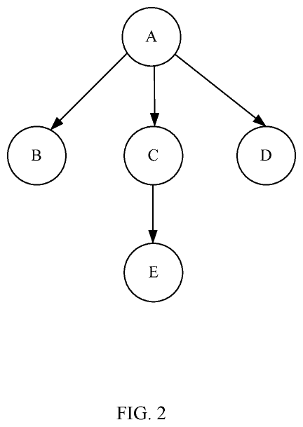

FIG. 2 is a schematic diagram of an operator graph according to the present disclosure. As shown in FIG. 2, to simplify the figure, only five nodes, namely five operators, are shown.

The order in which operators in the operator graph are traversed may be determined according to actual needs, and is not limited in the present embodiment, for example, a width-first traversal method may be employed.

Regarding any operator traversed, condition analysis may be performed for it to determine whether the operator satisfies a spatial reuse condition. As stated in step 102, if it is determined according to the analysis result that the operator satisfies the spatial reuse condition, the operator may be regarded as the found operator supporting spatial reuse.

As a preferred implementation, for any operator traversed, if it is determined that an input space corresponding to the input of the operator is not shared with other operators, and an output space corresponding to the output of the operator is not shared with other operators, it may be determined that the operator satisfies the spatial reuse condition, and the other operators are operators other than this operator.

That is, for any operator traversed, whether the operator satisfies the spatial reuse condition may be determined according to the data transmission relationship between the operators. If the input space corresponding to the input of the operator is not commonly read by multiple operators, and if the output space corresponding to the output of the operator is not commonly written by multiple operators, it may be determined that the operator satisfies the spatial reuse condition.

In the above manner, the operator that satisfies the spatial reuse condition, i.e., the operator supporting spatial reuse, may be found from lookup accurately and quickly.

For any operator supporting spatial reuse, the input and output of the operator may also be configured to be directed to the same space, that is, the output data may be directly written to the position of the input data, thereby realizing spatial reuse without occurrence of a calculation error.

In addition, for any operator supporting spatial reuse, a flag bit may also be set for the operator, and the flag bit is used to identify the operator as an operator supporting spatial reuse.

With the flag bit being set, the operator may acquire its own identity, namely, the operator supporting spatial reuse. When the operator operates, some corresponding processing may be performed according to the identity. For example, an operator is used to perform data transfer, i.e., transfer the data in the input space to the output space. If spatial reuse is performed, it is unnecessary to perform the data transfer process, thereby saving the processing time and improving data processing efficiency.

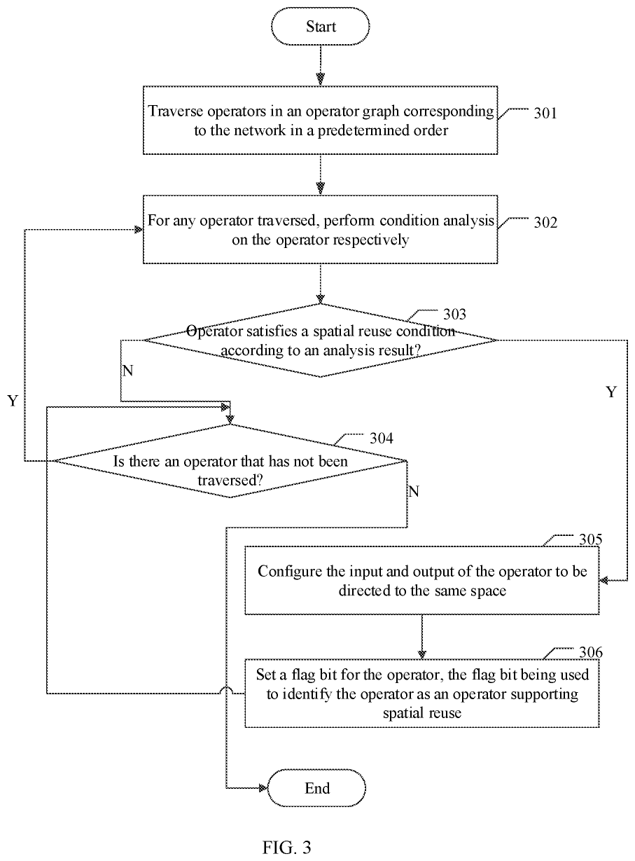

Based on the foregoing introduction, FIG. 3 is a flowchart of a second embodiment of the network operator processing method according to the present disclosure. As shown in FIG. 3, the following specific implementation is included.

In step 301, operators in an operator graph corresponding to the network are traversed in a predetermined order.

Nodes in the operator graph correspond to different operators in the network, respectively, and the corresponding nodes are connected by edges according to the data transmission relationship between the operators.

How to acquire the operator graph corresponding to the network is of the prior art.

In step 302, for any operator traversed, condition analysis is performed on the operator.

In step 303, it determines whether the operator satisfies a spatial reuse condition according to an analysis result, and step 304 is performed if NO, or step 305 is performed if YES.

For example, for any operator traversed, if it is determined that an input space corresponding to the input of the operator is not shared with other operators, and an output space corresponding to the output of the operator is not shared with other operators, it may be determined that the operator satisfies the spatial reuse condition, and the other operators are operators other than this operator.

Operator C shown in FIG. 2 is taken as an example. When determining whether the operator C satisfies the spatial reuse condition, it may first determine whether the input space corresponding to the input of the operator C is common with other operators, i.e., whether the input (there may be multiple inputs; take one input as an example) of the operator C will be used by operators other than operator C. And if YES, it is determined that operator C does not satisfy the spatial reuse condition.

Assuming that the input space corresponding to the input of operator C will be used by operator B and operator D, in practical application it is impossible to ensure which of operator B, operator C and operator D is first executed; assuming operator C is first executed and spatial reuse is performed, the data in the input space corresponding to operator C will be altered (altered to the output data of operator C), thereby causing the input data of operator B and operator D to be different from original correct data, i.e., an error occurs. Therefore, in this case, the operator C does not satisfy the spatial reuse condition.

Assuming that the input space corresponding to the input of operator C is not shared with other operators, it may further determine whether the output space corresponding to the output of operator C is shared with other operators. And if YES, it is determined that operator C does not satisfy the spatial reuse condition, or if NO, it is determined that the operator C satisfies the spatial reuse condition.

Assuming that the output space corresponding to the output of operator C will be shared by operator B and operator D, and assuming that operator B is executed first, the output data of operator B is stored in the output space; after operator C is executed later, if spatial reuse is performed, the input data of operator C becomes the output data of operator B, thereby causing an error to occur. Therefore, in this case, operator C does not satisfy the spatial reuse condition.

In step 304, it determines whether there is an operator that has not been traversed. If YES, step 302 is performed repeatedly for the next operator that is traversed, or if NO, the process ends.

In step 305, the input and output of the operator are configured to be directed to the same space.

In step 306, a flag bit is set for the operator, the flag bit being used to identify the operator as an operator supporting spatial reuse, and then step 304 is executed.

Subsequently, how to execute each operator in the operator graph is of the prior art.

As appreciated, for ease of description, the aforesaid method embodiments are all described as a combination of a series of actions, but those skilled in the art should appreciated that the present disclosure is not limited to the described order of actions because some steps may be performed in other orders or simultaneously according to the present disclosure. Secondly, those skilled in the art should appreciate the embodiments described in the description all belong to preferred embodiments, and the involved actions and modules are not necessarily requisite for the present disclosure. In addition, reference may be made to related depictions in other embodiments for portions not detailed in a certain embodiment.

To sum up, with the solution in the above method embodiment being employed, the operator that supports spatial reuse in the network can be automatically found from lookup, thereby saving manpower and time costs, and avoiding errors that might occur in manual operations, thereby improving the accuracy of the lookup result.

In addition, in the prior art, it is further necessary to manually add, in the network configuration, an option about whether to perform spatial reuse, and, after selecting an operator that requires spatial reuse, amend an execution code of the operator. In the solution of the method embodiment of the present disclosure, relevant processing may be automatically completed, thereby saving manpower and time costs.

Furthermore, the solution in the method embodiment of the present disclosure may be adapted for any network structure, and has general applicability.

The method embodiment is introduced above. The solution of the present disclosure will be further described hereunder through a system embodiment.

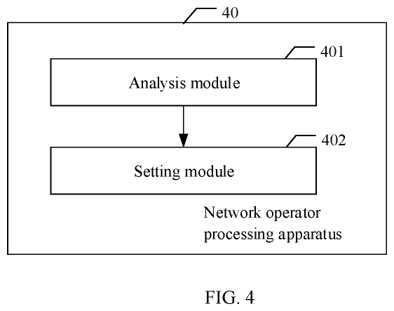

FIG. 4 illustrates a structural schematic diagram of an embodiment of a network operator processing apparatus 40 according to the present disclosure. As shown in FIG. 4, the apparatus comprises an analysis module 401.

The analysis module 401 is configured to, regarding any operator in the network, perform condition analysis on the operator respectively, and regard the operator as an operator supporting spatial reuse and found from lookup if it is determined according to an analysis result that the operator satisfies a spatial reuse condition.

As a preferred embodiment, the analysis module 401 is configured to traverse operators in an operator graph corresponding to the network, wherein nodes in the operator graph correspond to different operators in the network, respectively, and corresponding nodes are connected by edges according to a data transmission relationship between the operators; as for any operator traversed, perform condition analysis on the operator respectively.

An order in which operators in the operator graph are traversed may be determined according to actual needs, and is not limited in the present embodiment.

Regarding any operator traversed, the analysis module 401 may perform condition analysis on it to determine whether the operator satisfies a spatial reuse condition, and if it is determined according to the analysis result that the operator satisfies the spatial reuse condition, regard the operator as the found operator supporting spatial reuse.

As a preferred implementation, the analysis module 401 may, for any operator traversed, if it is determined that an input space corresponding to input of the operator is not shared with other operators, and an output space corresponding to output of the operator is not shared with other operators, determine that the operator satisfies the spatial reuse condition, and regard the other operators as operators other than the operator.

That is, for any operator traversed, whether the operator satisfies the spatial reuse condition may be determined according to the data transmission relationship between the operators. If the input space corresponding to the input of the operator is not commonly read by multiple operators, and if the output space corresponding to the output of the operator is not commonly written by multiple operators, it may be determined that the operator satisfies the spatial reuse condition.

In addition, as shown in FIG. 4, the apparatus may further comprise: a setting module 402.

The setting module 402 is configured to, for any operator supporting spatial reuse, configure the input and output of the operator to be directed to the same space.

In addition, the setting module 402 is further configured to, for any operator supporting spatial reuse, set a flag bit for the operator, the flag bit being used to identify the operator as an operator supporting spatial reuse.

Reference may be made to corresponding depictions in the aforesaid method embodiment for a specific workflow of the apparatus embodiment shown in FIG. 4. The workflow is not detailed any more.

To sum up, with the solution in the above apparatus embodiment being employed, the operator that supports spatial reuse in the network may be automatically found from lookup, thereby saving manpower and time costs, and avoiding errors that might occur in manual operations, thereby improving the accuracy of the lookup result.

In addition, in the prior art, it is further necessary to manually add, in the network configuration, an option about whether to perform spatial reuse, and, after selecting an operator that requires spatial reuse, amend an execution code of the operator. In the solution of the apparatus embodiment of the present disclosure, relevant processing may be automatically completed, thereby saving manpower and time costs.

Furthermore, the solution in the apparatus embodiment of the present disclosure may be adapted for any network structure, and has general applicability.

The solution of the present invention may be applied to the field of artificial intelligence, particularly to the field of deep learning and knowledge graph. Artificial intelligence is a branch of science concerned with using a computer to simulate a human being's some thinking processes and intelligent behaviors (e.g., learning, reasoning, thinking, planning etc.) and integrates techniques at the hardware level and techniques at the software level. Artificial intelligence hardware techniques generally include sensors, dedicated artificial intelligence chips, cloud computing, distributed storage, big data processing etc. Artificial intelligence software techniques mainly include major aspects such as compute vision technique, speech recognition technique, natural language processing technique, machine learning/deep learning, big data processing technique, and knowledge graph technique.

According to embodiments of the present disclosure, the present disclosure further provides an electronic device and a readable storage medium.

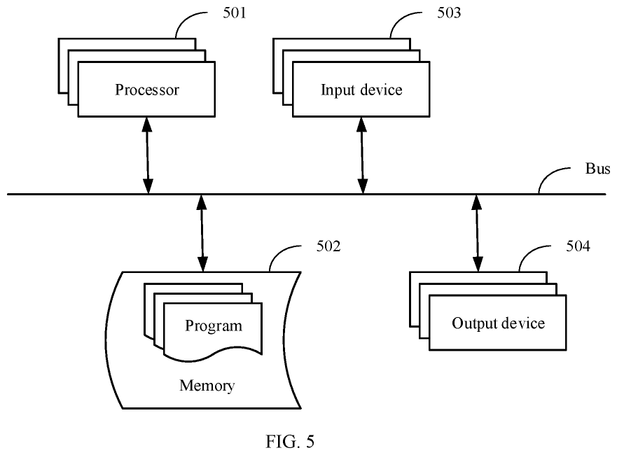

FIG. 5 illustrates a block diagram of an electronic device for implementing the method according to embodiments of the present disclosure. The electronic device is intended to represent various forms of digital computers, such as laptops, desktops, workstations, personal digital assistants, servers, blade servers, mainframes, and other appropriate computers. The electronic device is further intended to represent various forms of mobile devices, such as personal digital assistants, cellular telephones, smartphones, wearable devices and other similar computing devices. The components shown here, their connections and relationships, and their functions, are meant to be exemplary only, and are not meant to limit implementations of the inventions described and/or claimed in the text here.

As shown in FIG. 5, the electronic device comprises: one or more processors 501, a memory 502, and interfaces configured to connect components and including a high-speed interface and a low speed interface. Each of the components are interconnected using various buses, and may be mounted on a common motherboard or in other manners as appropriate. The processor can process instructions for execution within the electronic device, including instructions stored in the memory or on the storage device to display graphical information for a GUI on an external input/output device, such as a display device coupled to the interface. In other implementations, multiple processors and/or multiple buses may be used, as appropriate, along with multiple memories and types of memory. Also, multiple electronic devices may be connected, with each device providing portions of the necessary operations (e.g., as a server bank, a group of blade servers, or a multi-processor system). One processor 501 is taken as an example in FIG. 5.

The memory 502 is a non-transitory computer-readable storage medium provided by the present disclosure. The memory stores instructions executable by at least one processor, so that the at least one processor executes the method according to the present disclosure. The non-transitory computer-readable storage medium of the present disclosure stores computer instructions, which are used to cause a computer to execute the method according to the present disclosure.

The memory 502 is a non-transitory computer-readable storage medium and can be used to store non-transitory software programs, non-transitory computer executable programs and modules, such as program instructions/modules corresponding to the method in embodiments of the present disclosure. The processor 501 executes various functional applications and data processing of the server, i.e., implements the method in the above method embodiments, by running the non-transitory software programs, instructions and modules stored in the memory 502.

The memory 502 may include a storage program region and a storage data region, wherein the storage program region may store an operating system and an application program needed by at least one function; the storage data region may store data created according to the use of the electronic device. In addition, the memory 502 may include a high-speed random access memory, and may also include a non-transitory memory, such as at least one magnetic disk storage device, a flash memory device, or other non-transitory solid-state storage device. In some embodiments, the memory 502 may optionally include a memory remotely arranged relative to the processor 501, and these remote memories may be connected to the electronic device through a network. Examples of the above network include, but are not limited to, the Internet, an intranet, a blockchain network, a local area network, a mobile communication network, and combinations thereof.

The electronic device may further include an input device 503 and an output device 504. The processor 501, the memory 502, the input device 503 and the output device 504 may be connected through a bus or in other manners. In FIG. 5, the connection through the bus is taken as an example.

The input device 503 may receive inputted numeric or character information and generate key signal inputs related to user settings and function control of the electronic device, and may be an input device such as a touch screen, keypad, mouse, trackpad, touchpad, pointing stick, one or more mouse buttons, trackball and joystick. The output device 504 may include a display device, an auxiliary lighting device (e.g., an LED), a haptic feedback device (for example, a vibration motor), etc. The display device may include but not limited to a Liquid Crystal Display (LCD), a Light Emitting Diode (LED) display, and a plasma display. In some embodiments, the display device may be a touch screen.

Various implementations of the systems and techniques described here may be realized in digital electronic circuitry, integrated circuitry, specially designed ASICs (Application Specific Integrated Circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to send data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems and techniques described here), or any combination of such back end, middleware, or front end components. The components of the system may be interconnected by any form or medium of digital data communication (e.g., a communication network). Examples of communication networks include a local area network, a wide area network, a block chain network, and the Internet.

The computing system may include clients and servers. A client and server are generally remote from each other and typically interact through a communication network. The relationship of client and server arises by virtue of computer programs running on the respective computers and having a client-server relationship to each other. The server may be a cloud server, also referred to as a cloud computing server or a cloud host, and is a host product in a cloud computing service system to address defects such as great difficulty in management and weak service extensibility in a traditional physical host and VPS (Virtual Private Server) service.

It should be understood that the various forms of processes shown above can be used to reorder, add, or delete steps. For example, the steps described in the present disclosure can be performed in parallel, sequentially, or in different orders as long as the desired results of the technical solutions disclosed in the present disclosure can be achieved, which is not limited herein.

The foregoing specific implementations do not constitute a limitation on the protection scope of the present disclosure. It should be understood by those skilled in the art that various modifications, combinations, sub-combinations and substitutions can be made according to design requirements and other factors. Any modification, equivalent replacement and improvement made within the spirit and principle of the present disclosure shall be included in the protection scope of the present disclosure.

What is claimed is:

1. A network operator processing method, comprising:
regarding any operator in the network, performing condition analysis on the operator respectively; and
regarding the operator as an operator supporting spatial reuse and found from lookup if it is determined according to an analysis result that the operator satisfies a spatial reuse condition.

2. The method according to claim 1, wherein the step of, regarding any operator in the network, performing condition analysis on the operator respectively comprises:
traversing operators in an operator graph corresponding to the network, where nodes in the operator graph correspond to different operators in the network, respectively, and corresponding nodes are connected by edges according to a data transmission relationship between the operators; and
as for any operator traversed, performing condition analysis on the operator respectively.

3. The method according to claim 1, wherein the determining according to an analysis result that the operator satisfies a spatial reuse condition comprises:
if it is determined that an input space corresponding to input of the operator is not shared with other operators, and an output space corresponding to output of the operator is not shared with other operators, determining that the operator satisfies the spatial reuse condition, and regarding the other operators as operators other than the operator.

4. The method according to claim 1, further comprising:
for any operator supporting spatial reuse, configuring the input and output of the operator to be directed to the same space.

5. The method according to claim 1, further comprising:
for any operator supporting spatial reuse, setting a flag bit for the operator, the flag bit being used to identify the operator as an operator supporting spatial reuse.

6. An electronic device, comprising:
at least one processor; and
a memory communicatively connected with the at least one processor;
wherein the memory stores instructions executable by the at least one processor, and the instructions are executed by the at least one processor to enable the at least one processor to perform a network operator processing method, wherein the method comprises:
regarding any operator in the network, performing condition analysis on the operator respectively; and
regarding the operator as an operator supporting spatial reuse and found from lookup if it is determined according to an analysis result that the operator satisfies a spatial reuse condition.

7. The electronic device according to claim 6, wherein the step of, regarding any operator in the network, performing condition analysis on the operator respectively comprises:
traversing operators in an operator graph corresponding to the network, where nodes in the operator graph correspond to different operators in the network, respectively, and corresponding nodes are connected by edges according to a data transmission relationship between the operators; and
as for any operator traversed, performing condition analysis on the operator respectively.

8. The electronic device according to claim 6, wherein the determining according to an analysis result that the operator satisfies a spatial reuse condition comprises:
if it is determined that an input space corresponding to input of the operator is not shared with other operators, and an output space corresponding to output of the operator is not shared with other operators, determining that the operator satisfies the spatial reuse condition, and regarding the other operators as operators other than the operator.

9. The electronic device according to claim 6, further comprising:
for any operator supporting spatial reuse, configuring the input and output of the operator to be directed to the same space.

10. The electronic device according to claim 6, further comprising:
for any operator supporting spatial reuse, setting a flag bit for the operator, the flag bit being used to identify the operator as an operator supporting spatial reuse.

11. A non-transitory computer readable storage medium with computer instructions stored thereon, wherein the computer instructions are used for causing a computer to perform a network operator processing method, wherein the method comprises:
regarding any operator in the network, performing condition analysis on the operator respectively; and
regarding the operator as an operator supporting spatial reuse and found from lookup if it is determined according to an analysis result that the operator satisfies a spatial reuse condition.

12. The non-transitory computer readable storage medium according to claim 11, wherein the step of, regarding any operator in the network, performing condition analysis on the operator respectively comprises:
traversing operators in an operator graph corresponding to the network, where nodes in the operator graph correspond to different operators in the network, respectively, and corresponding nodes are connected by edges according to a data transmission relationship between the operators; and
as for any operator traversed, performing condition analysis on the operator respectively.

13. The non-transitory computer readable storage medium according to claim 11, wherein the determining according to an analysis result that the operator satisfies a spatial reuse condition comprises:
if it is determined that an input space corresponding to input of the operator is not shared with other operators, and an output space corresponding to output of the operator is not shared with other operators, determining that the operator satisfies the spatial reuse condition, and regarding the other operators as operators other than the operator.

14. The non-transitory computer readable storage medium according to claim 11, further comprising:
for any operator supporting spatial reuse, configuring the input and output of the operator to be directed to the same space.

15. The non-transitory computer readable storage medium according to claim 11, further comprising:
for any operator supporting spatial reuse, setting a flag bit for the operator, the flag bit being used to identify the operator as an operator supporting spatial reuse.
